(19) United States
(12) Patent Application Publication
(10) Pub. No.: US 2004/0249567 A1
(43) Pub. Date: Dec. 9, 2004

(54) Detection of the change of position of a vehicle occupant in an image sequence

(76) Inventor: Christoph Stiller, Ettlingen (DE)

Correspondence Address: KENYON & KENYON, ONE BROADWAY, NEW YORK, NY, 10004, US

(21) Appl. No.: 10/478,671

(22) PCT Filed: Jul. 9, 2002
(86) PCT No.: PCT/DE02/02500

(30) Foreign Application Priority Data
Jul. 10, 2001 (DE) 101 33 386.2

(51) Int. Cl. G01C 21/26

(52) U.S. Cl. 701/207; 701/208

(57) ABSTRACT

A method and a device for detecting an actual position of a person within a specifiable area are provided, which make it possible to improve the reliability, particularly in dynamic situations. The specifiable area is monitored using an image-recording device, and the recorded images are processed by an evaluation device. If a person is detected in the monitored area, at least one significant feature of the person is determined, the further analysis then being limited to this at least one significant feature, and if there is a relative change in position of this at least one significant feature beyond a specifiable minimum, an event signal is generated.

### FIELD OF THE INVENTION

The present invention relates to a method and a device for detecting an actual position of a person within a specifiable area, the specifiable area being monitored using an image-recording device.

### BACKGROUND INFORMATION

U.S. Pat. No. 5,983,147 discloses monitoring the scene of a front-passenger seat of a motor vehicle using video sensors, using a stereo camera in particular. By analysis of the recorded scene, it is determined whether the front-passenger seat is occupied. If it is determined that the front-passenger seat is occupied, it is furthermore possible to determine whether a large person (adult) or a small person (child) or another object is located on it. As a function of this obtained knowledge, it is possible to influence the activation of a front passenger airbag. It is known that the triggering of an airbag may pose considerable risk of injury for small persons in particular, due to the relative small distance to the airbag. The method disclosed in U.S. Pat. No. 5,983,147 makes it possible, when a head/chest area of a front-seat passenger is recognized in the airbag deployment area, to decide whether the front passenger airbag should not—or at least not completely—be triggered in an accident situation. The video cameras used for such image monitoring deliver images having a high optical resolution of several million pixels at a temporal resolution of approximately 25 images per second. This corresponds to an interval of one image every 40 ms. Such a temporal resolution is suitable for static monitoring. If, however, dynamic monitoring is required, the known method is disadvantageous in that a relatively high imprecision exists. It is known that in accident situations, a high deceleration affecting persons located in the vehicle occurs, which results in a very rapid change in the actual position of the person, so that the position of the person in relation to the airbag changes before it is triggered. The danger thus exists that the time delay causes the image analysis to incorrectly conclude that a person is located outside of a danger area while, however, the person is actually located within the danger area.

The object of the present invention is to specify a method and a device for determining an actual position of a person within a specified area, via which method and device the reliability of position determination may be improved in dynamic situations.

### SUMMARY OF THE INVENTION

In accordance with the present invention, a specified area, e.g., in an area of a vehicle, is monitored using an image-recording device, and the recorded images are processed by an evaluation device. If a person is detected in the specified area, at least one significant feature of the person is determined (identified), and the further analysis is limited to this at least one significant feature. In the event of a relative change in position of this at least one significant feature an event signal is generated. It is possible to detect the position of specific body parts of a person, such as the person's head/chest area, at a repetition rate far exceeding the rate of prior art image-recording or analysis. In particular, the present invention optimally takes into consideration the dynamic behavior of a person in the area to be monitored when detecting the actual position. In particular, the limitation of the further analysis to the at least one significant feature of the person makes it possible to substantially reduce the data involved in the analysis, making it possible to utilize the existing computer capacity for a higher repetition rate.

The device according to the present invention includes an image-recording device to record a specified area and an evaluation device to process the recorded images, the evaluation device having means to determine (identify) at least one significant feature of a detected person, and means to detect and report a relative change in position of the at least one significant feature. In this manner, it is possible to record the actual position of a person within the specifiable area reliably and rapidly in a simple manner.

Furthermore, in accordance with the present invention, it is possible to adjust the functions of the safety device individually to the type and/or the momentary actual position of a vehicle occupant, in particular a person located in the front-passenger seat. In particular, the safety of occupant groups particularly at risk, such as small children or persons of small body size, is increased. Furthermore, a control of the at least one safety device adapted to the situation is also possible for persons of larger body size.

### BRIEF DESCRIPTION OF THE DRAWINGS

FIG. 1 shows a schematic view of a motor vehicle containing an exemplary embodiment of the device according to the present invention.

FIG. 2 shows a flow chart of the method according to the present invention. FIG. 3 is a diagram approximately illustrating significant features of a person as an example.

### DETAILED DESCRIPTION

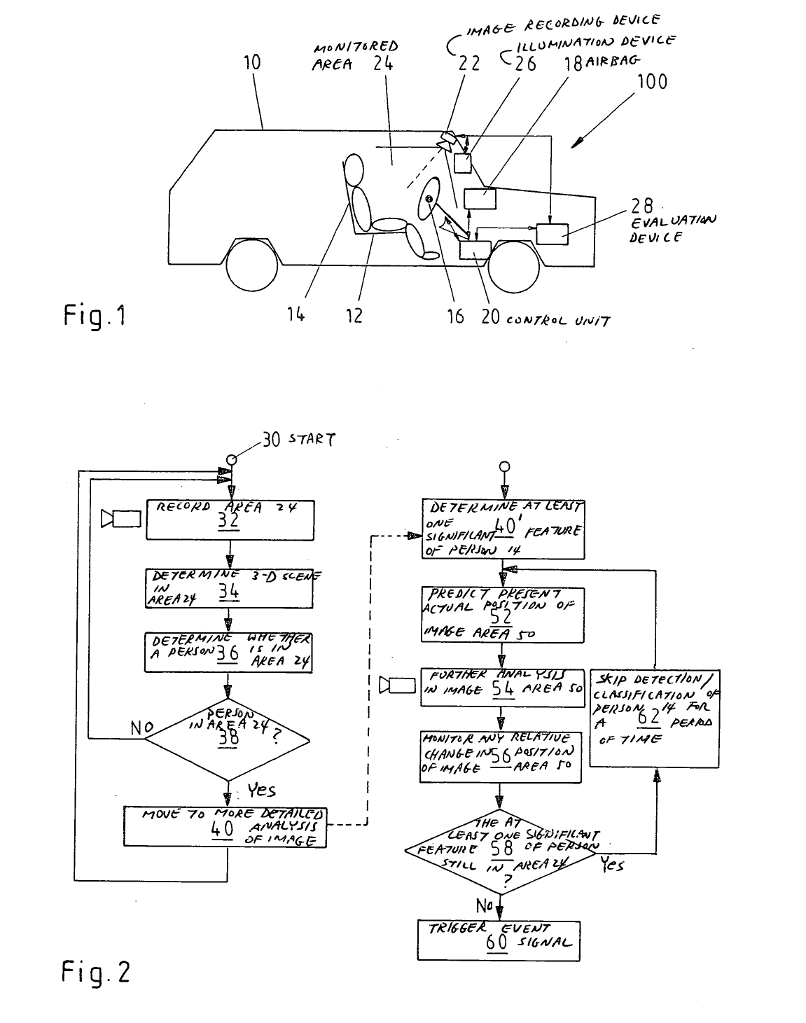

FIG. 1 shows a motor vehicle identified in its entirety as 10 in schematic form. Vehicle 10 has at least one vehicle seat 12 on which a person 14 is sitting. In the following description, it is assumed that the person is a front-seat passenger of motor vehicle 10. The present invention may also be readily transferred to a driver of motor vehicle 10 and/or to a person sitting on a rear bench seat (not shown) if the safety devices to be explained below are provided at these seats.

Active safety devices, for example, a steering system 16 and/or a brake system and passive safety devices, for example, an airbag 18, seat-belt tighteners (not shown), or the like are assigned to the particular person 14. The active and/or passive safety devices may be actuated by a control unit 20.

An image-recording device 22 is assigned to vehicle seats 12, via which a specifiable area 24 may be monitored. Either a separate image-recording device 22 (having a separate specifiable area 24 assigned to it) may be assigned to each vehicle seat 12 or a common image-recording device 22 is assigned to a plurality of vehicle seats 12. Image-recording device 22 is, for example, a CMOS stereo camera. An illumination device 26 to illuminate area 24 is optionally assigned to image-recording device 22. Illumination device 26 may, for example, function in the infrared range. Image-recording device 22 is connected to an evaluation device 28, which for its part is connected to control unit 20.

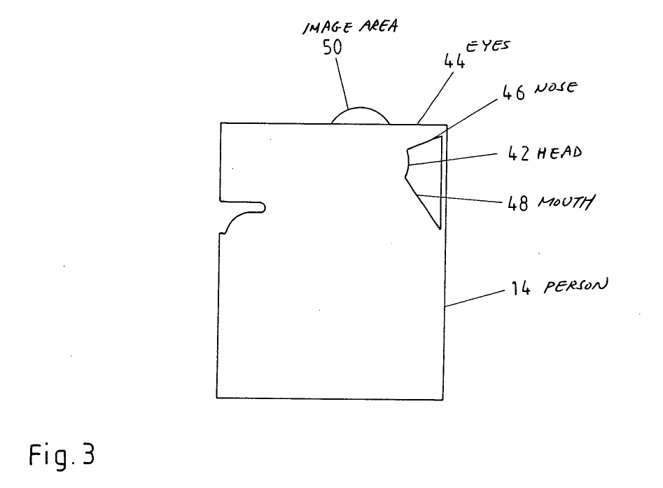

The function of the system shown in FIG. 1 is explained below based on the flow chart shown in FIG. 2.

After a start 30, which may be triggered, for example, by ignition of a driving motor of motor vehicle 10, image-recording device 22 takes a snapshot of area 24 to be monitored (step 32). The signals from image-recording device 22 corresponding to the actual depiction in area 24 are supplied to evaluation device 28. Images are read out of image-recording device 22 at an interval of several 10 ms, for example. Evaluation device 28 includes at least one processor for analyzing the signals delivered by image-recording device 22. As processors, for example, it is possible to use multitasking-capable processors or even non-multitasking-capable processors.

Image-recording device 22 is designed as a stereo camera so that, based on the shift of image contents between the two images of the stereo camera using triangulation methods, for example, it is possible to determine the distance from an object within area 24 to image-recording device 22. By linking the distances of a large number of individual pixels, it is possible to determine the scene occurring in area 24 in three-dimensional form (step 34). According to another embodiment, instead of the triangulation method, it is also possible to implement a three-dimensional determination by measuring the transfer time of the light pulses (range imager) emitted by image-recording device 22.

Subsequently, it is determined in a step 36 whether a person 14 is located in area 24. Person 14 may be detected from the image signals transmitted in three-dimensional form based on, for example, typical brightness patterns or based on typical shapes (head shape, head shape in relation to upper body shape, or the like). At the same time a person 14 is detected, the person is also classified. A classification may be made based on the appearance of the person in the categories relevant to the particular application. Categories for airbag 18 actuation may be, for example: the person is an infant in a rearward facing child seat, the person is a 3-year-old child, the person is a 6-year-old child, the person is an adult of small stature, the person is an adult of large stature, or the like.

The signal processing in step 36 is sent to a decision step 38, which decides whether a person 14 is located in area 24. If the answer is no, the method is restarted and begins again with step 32. If the answer is yes, a transfer 40 is made to another more detailed analysis of the recorded image in area 24. At the same time as the transfer, the process of detecting and classifying persons 14 in area 24 is restarted.

The further analysis of the recorded image is started by transfer 40 (step 40′). At least one significant feature of person 14 is determined from the recorded image of person 14 in area 24 available at this moment. These significant features of a person 14 may, for example, as shown in FIG. 3, be in the area of a head 42 and be defined by the position of the eyes 44 and/or nose 46 and/or mouth 48. After the at least one significant feature of person 14 is determined, image-recording device 22 is controlled via evaluation device 28 in such a way that only at least one image area of the entire image is further recorded and analyzed. This image area is identified in FIG. 3, for example, by reference numeral 50, within which significant features 44, 46, and 48 are located. If necessary, it is possible to reduce the size of the monitored image area further to one of significant features 44, 46, or 48. These further monitored image areas may be, for example, blocks that are 8×8 pixels in size.

In order to determine image areas 50 for further monitoring, a prediction of the present actual position is made from the position of relevant body parts of person 14 in the past in a step 52 (FIG. 2). In the simplest case, an area around the most recently determined position is used. In another embodiment, the position is determined in a linear manner from positions determined previously. If p(k) and p(k−1) identify the positions of a relevant image area 50 determined in the last point in time t(k) and at the penultimate point in time t(k−1), the present prediction is then calculated as

p(k+1)=p(k)+[p(k)−p(k−1)]*[t(k+1)−t(k)]/[t(k)31 t(k−1)].

According to this prediction of image areas 50 or of image area 50, which corresponds to the at least one significant feature of person 14, image area 50 is further recorded by image-recording device 22 and the further analysis is only performed in this image area 50 (step 54). In this connection, it is monitored whether there is a relative change in position of this at least one image area 50 (of the at least one significant feature of person 14) (step 56). In a decision step 58, it is then checked whether the at least one significant feature of person 14 and accordingly person 14 continues to be in area 24 and which momentary actual position person 14 assumes. If person 14 is no longer in area 24 or if a specific limiting value, for example, a minimum distance to airbag 18 is not met, an event signal 60 is triggered, which may be supplied to control unit 20 via evaluation device 28. Control unit 20 may then either prevent airbag 18 from being triggered or, for example, trigger only a partial deployment of airbag 18 (in the event of a crash).

Based on the explanation, it is made readily clear that after a previous basic detection of a person 14 in area 24 and a subsequent limitation of the monitoring to at least one image area 50 and accordingly one significant feature of person 14, a very much higher repetition rate of the analysis is possible so that it is even possible to detect dynamic events, for example, fast changes in position of person 14 due to deceleration in the event of a crash of motor vehicle 10, and it is possible to adapt the control of airbag 18 to them.

It is possible to achieve a further increase in the repetition rate of the analysis by blocking the process of detection and/or classification of person 14 (step 62) for at least a brief period of time if it is detected in decision step 58 that a person 14 continues to be in area 24 or a minimum distance to airbag 18 is met. This makes it possible to use the computer resources available for detection or classification to increase the repetition rate.

1-16 (canceled).

17. A method for determining an actual position of a person within at least one specified area, comprising:
monitoring the specified area using an image-recording device;
processing recorded images by an evaluation device, wherein, if a person is detected in the specified area, at least one significant feature of the person is determined;
determining a present actual position of the at least one significant feature based on a previous known position of the at least one significant feature; and
performing further analysis of recorded images, wherein the further analysis is limited to the at least one significant feature, and wherein recording of images is limited to at least one image area corresponding to the present position of the at least one significant feature of the person, and wherein, if there is a relative change in position of the at least one significant feature beyond a specified minimum threshold, an event signal is generated.

18. The method as recited in claim 17, wherein a three-dimensional image is formed of the specified area to being monitored.

19. The method as recited in claim 18, wherein the three-dimensional image is used to detect whether a person is located in the specified area being monitored.

20. The method as recited in claim 17, wherein the detection of a person in the specified area is based on one of a characteristic brightness pattern and a characteristic shape of a person.

21. The method as recited in claim 17, further comprising:
classifying the detected person in one of a plurality of classes.

22. The method as recited in claim 21, wherein the classification is based on one of age and stature of the detected person.

23. The method as recited in claim 17, wherein once the at least one significant feature of the detected person has been determined and the further analysis is limited to the at least one significant feature, the process of at least one of detecting and classifying a person is suspended for a specified period of time.

24. A device for determining an actual position of a person within at least one specified area, comprising:
an image-recording device for recording the specified area; and
an evaluation device for processing recorded images, wherein the evaluation device determines at least one significant feature of a detected person, and once the at least one significant feature has been determined, recording of images is limited to at least one image area corresponding to a present actual position of the at least one significant feature, and wherein the evaluation device detects a relative change in position of the at least one significant feature, and wherein the evaluation device determines the present actual position of the at least one significant feature based on a previous known position of the at least one significant feature.

25. The device as recited in claim 24, wherein the image-recording device is a stereo camera.

26. The device as recited in claim 24, further comprising:
an illumination device assigned to the image-recording device.

27. The device as recited in claim 24, wherein the evaluation device includes one of a multi-tasking-capable processor and a non-multi-tasking-capable processor.

28. The device as recited in claim 24, wherein the image-recording device records a plurality of specified areas.

29. The device as recited in claim 24, wherein a plurality of image-recording devices are provided, and the evaluation device processes recorded images from the plurality of image-recording devices.

30. The method as recited in claim 17, further comprising:
controlling operation of at least one safety device of a motor vehicle as a function of the event signal.

31. The method as recited in claim 30, wherein the at least one safety device is a passive safety device.

32. The method as recited in claim 31, wherein the passive safety device is an air-bag.
